(19) United States
(12) Patent Application Publication
(10) Pub. No.: US 2010/0006655 A1
(43) Pub. Date: Jan. 14, 2010

(54) SUB-CARD PERSONALIZATION PROCESS USING TEMPORARY ANTENNA

(76) Inventor: Simon Phillips, York (GB)

Correspondence Address: BUCKLEY, MASCHOFF & TALWALKAR LLC, 50 LOCUST AVENUE, NEW CANAAN, CT, 06840, US

(21) Appl. No.: 12/562,707

(22) Filed: Sep. 18, 2009

Related U.S. Application Data
(63) Continuation-in-part of application No. 11/852,739, filed on Sep. 10, 2007.
(60) Provisional application No. 61/102,054, filed on Oct. 2, 2008.
(60) Provisional application No. 60/843,044, filed on Sep. 8, 2006.

(51) Int. Cl. G06K 19/067; G06K 21/06

(52) U.S. Cl. 235/492; 235/495; 235/487

(57) ABSTRACT

A method includes providing an integrated circuit (IC) card that has a first size and is carried as part of a surrounding card. The surrounding card has a second size that is larger than the first size. The IC card includes an IC. The method further includes coupling a temporary antenna to the IC. In addition, the method includes transmitting to the IC via the temporary antenna an account number for storage in the IC. The account number is to be accessed with use of the IC card. Still further, the method includes detaching the temporary antenna from the IC, and installing the IC card in a wristwatch, wristband or bracelet to couple the IC to a second antenna included in the wristwatch, wristband or bracelet.

### CROSS-REFERENCE TO RELATED APPLICATIONS

This application claims priority under 35 U.S.C. § 119 to U.S. Provisional Patent Application Ser. No. 61/102,054, entitled “Sub-card personalization process using antenna-sticker on card-carrier assembly”, filed in the name of Simon Phillips on Oct. 2, 2008, the contents of which are hereby incorporated by reference.

Also, this application is a continuation-in-part of prior U.S. patent application Ser. No. 11/852,739, filed Sep. 10, 2007, which claims the benefit of U.S. Provisional Patent Application Ser. No. 60/843,044, filed Sep. 8, 2006.

### BACKGROUND

Proximity payment cards are in widespread use. A well known standard for such cards has been promulgated by MasterCard International Incorporated, the assignee hereof, and is referred to as “PayPass”. Proximity payment cards typically include a radio frequency identification (RFID) integrated circuit (IC) embedded in a card-shaped plastic body. An antenna is also embedded in the card body. The antenna is coupled to the RFID IC and allows the RFID IC to receive a power signal from a point of sale terminal. The antenna is also used by the RFID IC to transmit the payment card account number, and possibly other information as well, to the POS terminal.

Some proximity payment cards are issued in the familiar ID-1 format, as defined in ISO/IEC standard 7810. But it has also been proposed to issue proximity payment devices in other form factors, including fobs, for example. Moreover, it is has also been proposed to incorporate proximity payment functionality into devices such as mobile telephones and wristwatches. An example technique for assembling proximity-payment-enabled wristwatches is disclosed in the above-referenced patent application Ser. No. 11/852,739. (The '739 patent application was published as U.S. patent publication no. 2008/0061150 and has a common inventor herewith. The contents of the '150 publication are incorporated herein by reference.)

The '150 publication discloses an assembly formed from an ID-000 IC card detachably held within a carrier that is shaped and dimensioned in the ID-1 format. The carrier includes an antenna that is coupled to the IC in the ID-000 card. The carrier/card assembly is processed by standard personalization equipment to wirelessly load, via the antenna, a payment card account number and related or analogous data into the IC in the ID-000 card. After personalization, the ID-000 card is removed from the carrier (thus being detached from the antenna, which remains in the carrier), and the carrier/antenna may be discarded. The now-detached ID-000 card is inserted into a device such as a wristwatch. Upon insertion of the ID-000 card into the wristwatch, an antenna in the wristwatch is coupled to the IC in the ID-000 card, so that the wristwatch can function as a proximity payment device.

The present inventor now proposes an alternative technique for facilitating and carrying out the personalization of an ID-000 card.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 is a plan view of a structure that includes a small IC card blank (also referred to as a “subcard”) and a larger carrier for the small IC card blank, in accordance with aspects of the present invention.

FIG. 2 is a view similar to FIG. 1, showing the structure with an antenna-sticker adhered thereto, in accordance with aspects of the present invention.

FIG. 3 is a flow chart that illustrates a process for personalizing a subcard and incorporating it into a device, in accordance with aspects of the present invention.

### DETAILED DESCRIPTION

In general, and for the purpose of introducing concepts of embodiments of the present invention, a card/carrier assembly is provided, as referred to above, but without an antenna being incorporated in the carrier. Instead, a label or sticker is adhered to the card/carrier assembly, with a temporary antenna included within the sticker and coupled to the IC in the subcard via contacts on the subcard. The resulting assembly of card/carrier plus sticker may be processed in conventional personalization equipment to accomplish the personalization of the subcard. In some embodiments, the antenna-sticker may also serve as an “activation label” in that it may include a printed notice informing the cardholder of a toll free number to call to activate the card, or similar information.

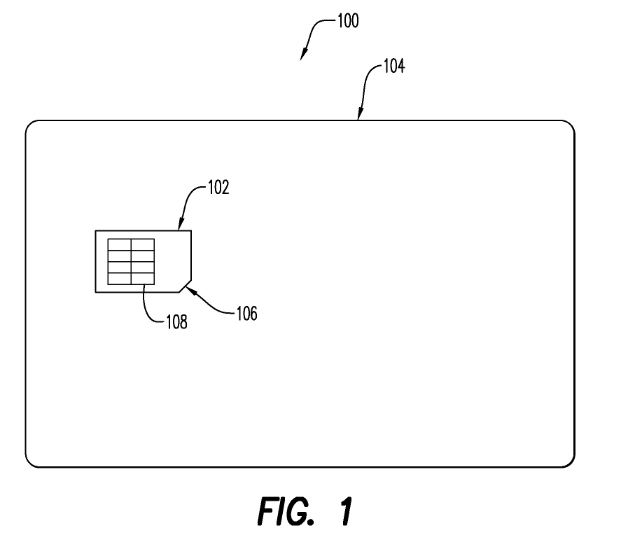

FIG. 1 is a plan view of a structure (card/carrier assembly) 100 that includes a small IC card blank (also referred to as a “subcard”) 102 and a larger carrier 104 for the subcard 102, in accordance with aspects of the present invention. The carrier 104 may be generally card-shaped and may have dimensions as defined for the standard card referred to as “ID-1” in ISO/IEC standard 7810, promulgated by the International Standardization Organization and other bodies. The subcard 102 may have dimensions as defined for the standard card/module referred to as “ID-000” in the same document no. 7810. The subcard 102 may be substantially defined within the body of the carrier 104 by substantial or nearly complete punching (also referred to as “cut-outs” or “voids”) or scoring of the body of the carrier 104, which punching or scoring is indicated at 106. The subcard 102 includes an IC indicated at 108, on which several electrically conductive contact pads (shown in the drawing but not separately assigned numerals) are formed. The contact pads may, for example, consist of eight contact pads sized and laid out in accordance with a widely used standard for contact IC cards. In some embodiments, the contact pads are made of copper. It will be noted that the contacts are present on a side of the subcard 102. (The side of the subcard 102 which displays the contacts will in at least some cases be referred to as the front side of the subcard 102.) The contact pads may also be referred to simply as “contacts”. The contacts are electrically conductively coupled to the IC 108.

The carrier 104 constitutes a “surrounding card” that surrounds and carries the subcard 102. At will be noted that the carrier 104 has a size that is larger than the size of the subcard 102.

One or more surfaces of the subcard 102 may carry one or more logos and/or brands, including for example the brand/logo of a national payment card association such as MasterCard International Incorporated, the assignee hereof. The brand/logo of the issuer may also be present, as well as, for example, a specific card product brand.

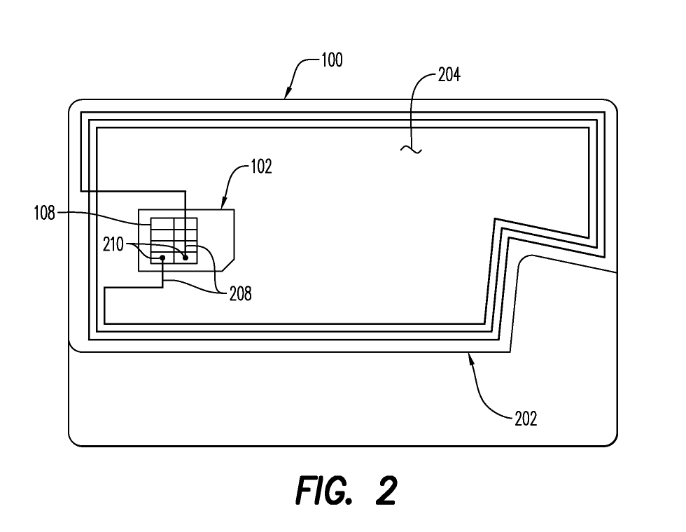

FIG. 2 is a view similar to FIG. 1, showing the card/carrier assembly 100 with an antenna-sticker 202 adhered thereto, in accordance with aspects of the present invention. The antenna-sticker 202 may be constituted primarily by a body 204 formed of a thin self adhesive film, or the like. The body 204 of the sticker 202 has an antenna 206 embedded and/or carried thereon. The antenna 206 may take the form of several loops that run along the periphery of the body 204 of the sticker 202, as shown in FIG. 2. The antenna loops may, for example, be formed from a conductive material that is printed on the body 204. Alternatively, the antenna 206 may be of a different type and/or configuration.

The antenna 206 has terminals 208 that are electrically conductively coupled in a suitable manner (e.g., by blobs 210 of electrically conductive adhesive) to certain ones of the contacts (e.g., the contacts referred to as C4 and C8 in certain standards). Thus, in some manner electrically conductive connections are present between the antenna 206 and the contacts on the IC 108.

Although not shown in the drawing, information may be printed on the antenna-sticker 202. As noted above, this information may include a notice for the cardholder, for advising the cardholder of a telephone number to be called to activate the card.

The combination of the card/carrier assembly 100 with the antenna-sticker 202 attached thereto may be referred to as an integrated circuit card personalization assembly.

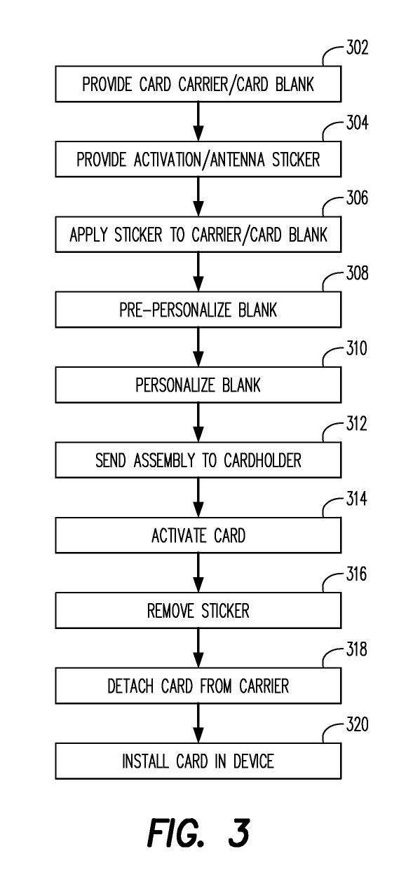

FIG. 3 is a flow chart that illustrates a process for personalizing the subcard 102 and incorporating it into a device, in accordance with aspects of the present invention.

At 302 in FIG. 3, the card/carrier assembly 100 (as illustrated in FIG. 1) is provided. At 304 in FIG. 3, the antenna-sticker 202—as described above in conjunction with FIG. 2—is provided. At 306, the antenna-sticker 202 is applied to the card/carrier assembly 100 in such a manner that the antenna 206 (FIG. 2) is electrically conductively coupled to the IC 108 of the subcard 102.

At 306 in FIG. 3, a process step customarily referred to as “pre-personalization” is performed with respect to the subcard 102. As is familiar to those who are skilled in the art, pre-personalization entails writing into the IC of a payment card (or similar device), via radio frequency communication (received by the IC 108 via the antenna 206), certain information such as loading of keys to be used in subsequent transactions and setting of parameters (such as to select a particular card brand to be borne by the subcard 102). In addition, information such as a payment card association brand, etc., may be printed on the subcard 102 as part of the pre-personalization process. It will be appreciated that the information stored in the IC 108 and/or printed on the subcard 102 may be such as is common to all small IC cards processed in a particular production run.

In some embodiments, the antenna-sticker 202 has a window (not shown) therein to allow information to be printed through the window on the subcard 102. In other embodiments, all printing on the subcard and/or on the carrier is on the opposite side of the subcard/carrier from the side to which the antenna-sticker has been attached.

At 310 in FIG. 3, a process step customarily referred to as “personalization” is performed with respect to the subcard 102. In the personalization step, the subcard 102 is effectively assigned to a particular payment card account and/or a particular account holder by writing into the IC 108 (again via radio frequency communication through the antenna 206) information such as a payment card account number and the name of the account holder. Other information, such as expiration date, may be stored in either of the pre-personalization and personalization steps. Moreover, the pre-personalization and personalization steps may be combined in one operation. Such an operation (or operations, if the steps are performed separately) may be performed by use of an item of conventional contactless card programming equipment, such as the model 9000 available from Datacard Group, Minnetonka, Minn. Because the integrated circuit card personalization assembly has substantially the same form factor as a standard ID-1 card, personalization processing can readily be performed on standard equipment, as referred to above. In some embodiments, the antenna-sticker 202 may provide an additional advantage in that it may cover the voids around the subcard 102, thereby accommodating handling of the integrated circuit card personalization assembly with a suction cup that is part of the personalization equipment. For background with respect to this potential advantage, reference is made to U.S. patent publication no. 2008/0068181, in which the voids around the subcard are positioned so as to be clear of the locus of the personalization equipment suction cup.

In accordance with some embodiments, personalization may also include printing, on the surface of the subcard 102, the payment card account number and/or any other information (or a portion thereof) that was (or is to be) stored in the IC 108. In accordance with some embodiments, the printing of the payment card account number on the subcard 102 may be by use of the above-mentioned Datacard 9000 equipment or by another suitable device with printing capabilities.

In some embodiments, information printed on the subcard 102 may be the same as and/or similar to information printed on a subcard in one or more embodiments disclosed in U.S. patent application Ser. No. 11/852,751, filed Sep. 10, 2007, published as U.S. patent publication no. 2008/0061151, and having a common inventor herewith, the contents of which are hereby incorporated by reference.

At 312 in FIG. 3, the integrated circuit card personalization assembly as shown in FIG. 2 is sent to the cardholder (e.g., by first class mail in a suitable envelope). At 314 in FIG. 3, the subcard 102 is activated in a conventional manner in response to the cardholder's telephone call in to the card issuer. At 316, the cardholder removes the antenna-sticker 202 from the card/carrier assembly 100.

At 318 in FIG. 3, the cardholder detaches the subcard 102 from the carrier 104. At 320 in FIG. 3, the subcard 102 is installed in a device (not shown) so that the device becomes a proximity payment device. The device may be, for example, a wristwatch, a wristband or a bracelet. The device may include an antenna (not shown) to which the IC 108 is coupled by the installation of the subcard 102 in the device.

The resulting proximity payment device may operate in a conventional manner. For example, the proximity payment device may operate in accordance with the above-mentioned “PayPass” standard. The proximity payment device may be presented to a proximity coupling device (not shown) of a POS terminal (not shown) to accomplish payment for a sales transaction. The proximity coupling device may transmit an interrogation signal. The proximity payment device may receive the interrogation signal via the device antenna. The received interrogation signal may cause the IC 108 to be powered-up. The IC 108 may transmit one or more signals to the proximity coupling device in response to the interrogation signal. The signals transmitted by the IC 108 may include a payment card account number and/or other information required for interaction with the proximity coupling device. The POS terminal may then interact with a payment card system to charge the current sales transaction to the payment card account represented by the payment card account number received from the proximity payment device.

In some embodiments, the card issuer, or a contractor for the card issuer, or a third party, may detach the subcard 102 from the card/carrier assembly and install the subcard 102 in the device (e.g., a wristwatch) that is to be payment-enabled. In this case, the resulting proximity payment card device may be sent to the cardholder prior to activation of the card account (and after the subcard has been detached from the card/carrier assembly), and activation of the card account may not occur until after the resulting proximity payment device is mailed to and received by the cardholder.

In some embodiments, use of an antenna-sticker as a temporary antenna for a personalization process, as disclosed herein, instead of providing an antenna in the carrier body, may result in cost savings.

The principles taught herein have heretofore been described in the context of proximity payment devices. Nevertheless, these teachings are also applicable to any type of identification token. As used herein and in the appended claims the term “identification token” refers to a device, of any shape, that serves as one or more of a proximity payment device, a transportation related device, an identification device, an RFID-enabled passport and/or a source of any type of information associated with a holder of the identification token (and/or the holder of the card installed therein). The term “transportation related device” refers to a card or other device used to pay, or confirm or evidence payment of, a charge for using a transportation system and/or cards or the like issued by transportation systems (e.g., mass transit systems) for access to the transportation systems. The term “RFID-enabled passport” refers to an internationally recognized travel document that includes an IC and an antenna and communicates with a terminal by a wireless communication technique. The term “information” may include but is not limited to a name, a social security number, an account number, an expiration date, a security code and/or medical information. As used herein, an account number may be numeric, non numeric and/or a combination thereof.

In some embodiments, the size of the subcard compared to the rest of the structure may be different than shown. Thus, the subcard need not be an ID-000 card.

As used herein, the term surrounding includes both completely surrounding and partially surrounding. Thus, a surrounding card may be a completely surrounding card and/or a partially surrounding card.

The above description and/or the accompanying drawings are not meant to imply a fixed order or sequence of steps for any process referred to herein; rather any process may be performed in any order that is practicable, including but not limited to simultaneous performance of steps indicated as sequential.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
providing an integrated circuit (IC) card having a first size and carried as part of a surrounding card having a second size larger than the first size, the IC card including an IC;
coupling a temporary antenna to the IC;
transmitting to the IC via the temporary antenna an account number for storage in the IC, the account number to be accessed with use of the IC card after the IC card is detached from the surrounding card;
detaching the temporary antenna from the IC; and
installing the IC card in a wristwatch, wristband or bracelet to couple the IC to a second antenna included in the wristwatch, wristband or bracelet.

2. The method of claim 1, wherein the temporary antenna is part of a sticker, said sticker adhered to the IC card and the surrounding card during the transmitting step.

3. The method of claim 1, wherein the account number corresponds to a payment card account.

4. The method of claim 1, further comprising:
transmitting to the IC via the antenna a name of a cardholder to whom the IC card is to be sent.

5. A method comprising:
providing an integrated circuit (IC) card having a first size and carried as part of a surrounding card having a second size larger than the first size, the IC card including an IC and electrically conductive contacts on a first side of the IC card, the contacts electrically conductively coupled to the IC;
adhering a sticker to the IC card and the surrounding card, the sticker including an antenna, the sticker being adhered to the IC card and the surrounding card such that the antenna is electrically conductively coupled to the contacts on the IC card; and
transmitting to the IC via the antenna an account number for storage in the IC, the account number to be accessed with use of the IC card.

6. The method of claim 5, further comprising:
providing an electrically conductive adhesive to form an electrically conductive connection between the antenna and the contacts on the IC card.

7. The method of claim 5, further comprising:
removing the sticker from the IC card; and
snapping the IC card out of the surrounding card.

8. The method of claim 7, further comprising:
installing the IC card in a wristwatch, wristband or bracelet to connect the IC to an antenna included in the wristwatch, wristband or bracelet.

9. The method of claim 5, further comprising:
printing information on the IC card through a window in the sticker.

10. The method of claim 5, wherein the IC card is an ID-000 card.

11. The method of claim 10, wherein the surrounding card has length and height dimensions in accordance with a standard ID-1 card.

12. The method of claim 5, further comprising:
transmitting to the IC via the antenna a name of a cardholder to whom the IC card is to be sent.

13. The method of claim 5, wherein the account number corresponds to a payment card account.

14. The method of claim 5, wherein, during the transmitting step, the sticker covers voices formed in the surrounding card, said voids defining the IC card within the surrounding card.

15. An integrated circuit (IC) card personalization assembly, comprising:
an IC card having electrically conductive contacts on the first side of the IC card;
a card-shaped carrier that surrounds the IC card, the IC card defined by scoring and/or voids within the carrier;
a sticker adhered to the carrier and the IC card, the sticker including an antenna; and
electrically conductive connections between the antenna and the contacts on the IC card.

16. The IC card personalization assembly of claim 15, wherein said electrically conductive connections are formed of electrically conductive adhesive.

17. The IC card personalization assembly of claim 15, wherein the IC card is an ID-000 card.

18. The IC card personalization assembly of claim 17, wherein the carrier has length and height dimensions in accordance with a standard ID-1 card.

19. The IC card personalization assembly of claim 15, wherein the sticker covers voids formed in the card-shaped carrier, said voids defining the IC card within the card-shaped carrier.
